(19) United States
(12) Patent Application Publication
(10) Pub. No.: US 2022/0397419 A1
(43) Pub. Date: Dec. 15, 2022

(54) SYSTEMS AND METHODS FOR SELECTING A NAVIGATION MAP

(71) Applicant: HERE GLOBAL B.V., Eindhoven (NL)

(72) Inventors: Leon Stenneth, CHICAGO, IL (US); JEROME BEAUREPAIRE, BERLIN (DE); JEREMY MICHAEL YOUNG, CHICAGO, IL (US)

(21) Appl. No.: 17/343,616

(22) Filed: Jun. 9, 2021

(51) Int. Cl. G01C 21/00

(52) U.S. Cl. CPC G01C 21/3815; G01C 21/3841

(57) ABSTRACT

Systems and methods for selecting a navigation map for utilization in a region are provided. For example, a method includes determining, for one or more areas, a plurality of scores corresponding respectively to a plurality of digital maps. The method further includes selecting a digital map of the plurality of digital maps based on a value of a score of the plurality of scores. The method further includes providing the selected digital map to a device to utilize one or more navigation functions in a location within the one or more areas.

### TECHNICAL FIELD

The present disclosure relates generally to mapping applications, products and services, and more specifically to systems and methods for selecting a navigation map.

### BACKGROUND

The use of digital maps and mapping applications has grown significantly. Such mapping applications may be executable by various types of user electronic devices. Examples of such devices include, but are not limited to, a computer connected to the Internet, an onboard navigation system in a vehicle, a dedicated portable Global Positioning System (GPS) device, a mobile computer device (e.g., a smartphone), a GPS-enabled computing device, etc. The displayed digital maps often convey information related to roads, traffic, buildings, landmarks, terrain, and other geographic locations or regions of interest. In some scenarios, a digital map from a map provider is better than a digital map from another map provider. However, there is no optimal way of knowing which digital map to choose between the digital maps of various map providers.

### BRIEF SUMMARY

The present disclosure overcomes the shortcomings of prior technologies. In particular, a novel approach for synchronization is provided, as detailed below.

In accordance with an aspect of the disclosure, a method of selecting a navigation map for utilization in a region is provided. The method includes determining, for one or more areas, a plurality of scores corresponding respectively to a plurality of digital maps. The method also includes selecting a digital map of the plurality of digital maps based on a value of a score of the plurality of scores. The method also includes providing the selected digital map to a device to utilize one or more navigation functions in a location within the one or more areas.

In accordance with another aspect of the disclosure, an apparatus is provided. The apparatus includes a processor. The apparatus also includes a memory comprising computer program code for one or more programs. The memory and the computer program code are configured to cause the processor of the apparatus to receive a score corresponding to a digital map. The computer program code is further configured to cause the processor of the apparatus to receive data captured via at least one or more sensors of a vehicle. The data captured corresponds to the digital map. The computer program code is further configured to cause the processor of the apparatus to determine a revised score corresponding to the digital map based on the data captured via the at least one or more sensors of the vehicle and map data of the digital map. The computer program code is further configured to cause the processor of the apparatus to update the score of the digital map based on the revised score.

In yet another aspect of the present disclosure, a non-transitory computer-readable storage medium is provided. The non-transitory computer-readable storage medium includes one or more sequences of one or more instructions for execution by one or more processors of a device with a display screen and one or more input devices. The one or more instructions which, when executed by the one or more processors, cause the device to identify location information associated with a vehicle. The one or more instructions further cause the device to determine scores for different applications based on the location information. The one or more instructions further cause the device to select an application of the different applications for the vehicle or device thereof based on a score of the determined scores.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention will hereafter be described with reference to the accompanying figures, wherein like reference numerals denote like elements. The embodiments described are presented by way of example, and not by way of limitation, in the accompanying drawings:

FIG. 1A is a schematic diagram of an example system, in accordance with aspects of the present disclosure;

FIG. 1B is a schematic diagram of another example system, in accordance with aspects of the present disclosure;

FIG. 2 is a diagram of an example digital map, in accordance with aspects of the present disclosure;

FIG. 3 is a diagram of an example scenario, in accordance with aspects of the present disclosure;

FIG. 4 is a diagram of another example digital map, in accordance with aspects of the present disclosure;

FIG. 5 a diagram of another example digital map, in accordance with aspects of the present disclosure;

FIG. 6 is a flowchart setting forth steps of an example process, in accordance with aspects of the present disclosure;

FIG. 7 is a flowchart setting forth steps of another example process, in accordance with aspects of the present disclosure;

FIG. 8 is a diagram of another example digital map, in accordance with aspects of the present disclosure;

FIG. 9 is a diagram of an example geographic database, in accordance with aspects of the present disclosure;

FIG. 10 is a diagram of an example computer system, in accordance with aspects of the present disclosure;

FIG. 11 is a diagram of an example chip set, in accordance with aspects of the present disclosure; and

FIG. 12 is a diagram of an example mobile device, in accordance with aspects of the present disclosure.

### DETAILED DESCRIPTION

In the following description, and for the purposes of explanation, numerous specific details are set forth to provide a thorough understanding of the embodiments. It should be apparent to one skilled in the art, however, that the embodiments may be practiced with or without these specific details, or with equivalent arrangements. In other instances, well-known structures and devices are shown in block diagram form in order to avoid unnecessarily obscuring the embodiments.

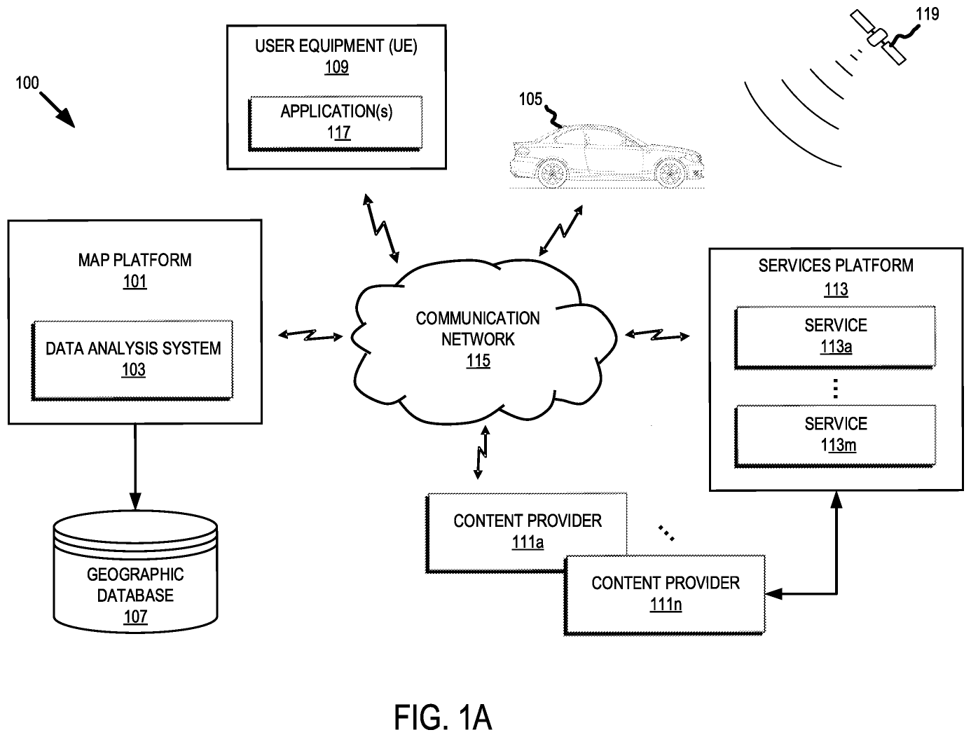

Referring particularly to FIG. 1A, a schematic diagram of a system 100, in accordance with aspects of the present disclosure, is shown. In general, the system 100 may be any device, apparatus, system, or a combination thereof, that is configured to carry out steps in accordance with the present disclosure. Specifically, the system 100 may include, be part of, or operate in collaboration with, various computers, systems, devices, machines, mainframes, networks, servers, databases, and so forth. In some embodiments, the system 100 may also include portable or mobile terminals or devices, such as cellular phones, smartphones, laptops, tablets, and the like. In this regard, the system 100 may be designed to integrate a variety of hardware, software, and firmware with various capabilities and functionalities. In addition, the system 100 may be capable of operating autonomously or semi-autonomously.

In some embodiments, the system 100 may include a map platform 101 configured to generate and process a variety of mapping information and data, as well as carry out steps in accordance with methods described herein. In addition, the map platform 101 may also communicate and exchange information and data with a variety of other systems, devices and hardware. For instance, as shown in FIG. 1, the map platform 101 may communicate with one or more vehicle(s) 105, geographic database(s) 107, user equipment (UE) 109, content provider(s) 111, and/or services platform(s) 113 by way of a communication network 115.

To carry out processing steps, in accordance with aspects of the present disclosure, the map platform 101, and components therein, may execute instructions or sequences of instructions stored in a non-transitory computer-readable medium (not shown in FIG. 1). The non-transitory computer-readable medium may be part of a memory, database, or other data storage location(s). To execute the instructions, the map platform 101 may include, and utilize a programmable processor, or combination of programmable processors. Alternatively, or additionally, the map platform 101, and components therein, may also include and utilize one or more dedicated processors, or processing units, modules or systems specifically configured (e.g., hardwired, or programmed) to carry out steps, in accordance with methods described herein. In addition, the map platform 101 may further include, and/or share, a variety of interconnected components, including servers, intelligent networking/computing devices and other components, as well as corresponding software and/or firmware. By way of example, processing steps may be carried out using any combination of central processing units (CPUs), graphics processing units (GPUs), Digital Signal Processing (DSP) chips, Application Specific Integrated Circuits (ASICs), Field Programmable Gate Arrays (FPGAs), and so forth.

In some embodiments, the map platform 101 may include a data analysis system 103, as illustrated in FIG. 1A. Although the data analysis system 103 is shown as being part of the map platform 101, the data analysis system 103 may be a stand-alone system. Alternatively, the data analysis system 103 may be a part of the vehicle 105, UE 109, services platform 113 or services 113a-m, or a combination thereof.

The data analysis system 103 may be configured to detect certain objects or features depicted in images, and utilize various algorithms (e.g., machine learning algorithms) implemented using various computing architectures. In some implementations, the data analysis system 103 may utilize one or more neural networks configured to make predictions based on various machine learning models. For example, the data analysis system 103 may utilize a neural network, such as a convolutional neural network, having multiple layers and neurons. Also, the data analysis system 103 may utilize receptive fields of a collection of neuron(s) (e.g., a receptive layer) configured to correspond to the area of interest in inputted imagery or data.

In some aspects, the data analysis system 103 may be configured to detect target features from imagery (e.g., top-down images, terrestrial images, and so forth), as well as identify various target points based on the features. The imagery can be obtained from a variety of different sources. For example, the imagery may be captured using aerial vehicles (e.g., airplanes, drones, and so forth), terrestrial vehicles (e.g., mapping vehicles, and the like), satellites, ground surveyors, device end-users, and using other equipment or methods.

In some aspects, target features or target points can be marked or labeled in a large of set of training images. Labeling involves identifying pixels within a given image that correspond to the point or feature. Labeling may be performed automatically using various techniques, manually by a human labeler, a combination of both. The labeled training images may be used to train the machine learning algorithms to find the target points or features in new imagery (i.e., predicting the pixel locations associated with points or features in the input images). In addition to generating data (e.g., position data) corresponding to detected points or features, the data analysis system 103 may also be configured to generate confidence values/uncertainties for the data (e.g., confidence or uncertainty in position).

In some implementations, the machine learning algorithms utilized by the data analysis system 103 may be trained to automatically label imagery depicting areas to be mapped or analyzed. In addition, three-dimensional (3D) coordinates of target points or features can be estimated using multiple views, whereby corresponding points or features are labeled in two or more images (e.g., terrestrial, aerial, and so forth). To this end, the map platform 101 and/or data analysis system 103 can determine pixel correspondences between various target points or features labeled in each of the images. The 3D coordinates can then be determined via a triangulation process from the pixel correspondences in combination with various camera information (e.g., model, position, pointing direction or pose, etc.) of the camera or camera system used to capture the images. Since different sources (e.g., satellites, airplanes, drones, etc.) often provide imagery of different quality and resolution, and uncertainty/error associated with the generated target points may also be computed.

The data analysis system 103 may also be configured to determine one or more scores corresponding to digital maps, in accordance with aspects of the present disclosure. In some aspects, the data analysis system 103 may be configured to receive or access image and position data acquired via one or more vehicles and determine one or more scores based on sensor data and map data. The data analysis system 104 may also be configured to select one or maps for navigation from a plurality of map providers based on the determined one or more scores corresponding to the digital maps.

The map platform 101 and/or data analysis system 103 may have connectivity or access to a geographic database 107. Specifically, the geographic database 107 may store various geographical data and information in a variety of forms and formats. For instance, in one embodiment, the geographic database 107 may include images or image data (e.g., terrestrial, aerial, etc.), drive data and so forth. The geographic database 107 may also include other geographical data and information, including GPS, GNSS, and other data/information for use in synchronizing sensors.

In addition, the map platform 101 may also communicate with UE 109 and/or a vehicle 105. In one embodiment, the UE 109, or alternatively the vehicle 105, may execute one or more applications 117 (e.g., software applications) configured to carry out steps in accordance with methods described here. For instance, in one non-limiting example, the application 117 may carry out steps for updating a score of a navigation map. In another non-limiting example, the application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103, and perform one or more functions associated with synchronizing sensors, either alone or in combination with the data analysis system 103.

By way of example, the UE 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1A as being separate from the vehicle 105, in some embodiments, the UE 109 may be integrated into, or part of, the vehicle 105.

In some embodiments, the UE 109 may be integrated in the vehicle 105, which may include assisted driving vehicles such as autonomous vehicles, highly assisted driving (HAD), and advanced driving assistance systems (ADAS). Any of these assisted driving systems may be incorporated into the UE 109. Alternatively, an assisted driving device may be included in the vehicle 105. The assisted driving device may include memory, a processor, and systems to communicate with the UE 109. The assisted driving vehicles may respond to the lane marking indicators (lane marking type, lane marking intensity, lane marking color, lane marking offset, lane marking width, or other characteristics) received from geographic database 107 and the map platform 101 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) received from geographic database 107 and the map platform 101 and driving commands or navigation commands. In certain embodiments, the autonomous level can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) received from geographic database 107 and the map platform 101 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) received from geographic database 107 and the map platform 101 and driving commands or navigation commands.

In some embodiments, the UE 109 and/or vehicle 105 may include various sensors for acquiring a variety of different data or information. For instance, the UE 109 and/or vehicle 105 may include one or more camera/imaging devices for capturing imagery (e.g., terrestrial images), global positioning sensors (GPS) or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or vehicle 105 may also include light sensors, height sensors, accelerometers (e.g., for determining acceleration and vehicle orientation), tilt sensors (e.g., for detecting the degree of incline or decline), moisture sensors, pressure sensors, and so forth. Further, the UE 109 and/or vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109 and/or vehicle 105.

The map platform 101 may also have connectivity with various content providers 111. Each content provider 111a-111n may send, or provide access to, various information or data to the data analysis system 103, vehicle 105, geographic database 107, user equipment 109, the services platform 113, and any combination thereof. The content provided may include map content (e.g., geographic data, parametric representations of mapped features, and so forth), textual content, audio content, video or image content (e.g., terrestrial image data), and so forth. In some implementations, the providers 111 may send, or provide access to, information or data for detecting and classifying various features/target points in image data. In some implementations, the providers 111 may also receive and store content from the data analysis system 103, vehicle 105, geographic database 107, UE 109, services platform 113, and any combination thereof. The content providers 111 may also manage access to a central repository of data, and offer a consistent, standard interface to data, such as a repository of the geographic database 107. In one example, the content providers 111 may provide mapping services, navigation services, travel planning services, notification services, social networking services, content (e.g., audio, video, images, etc.) provisioning services, application services, storage services, contextual information determination services, location-based services, information-based services (e.g., weather, news, etc.), and so forth

As shown in FIG. 1A, the map platform 101 may further connect over the communication network 115 to the services platform 113 (e.g., a third-party platform), which may provide one or more services 113a-m. By way of example, the services platform 113 may provide mapping services, navigation services, travel planning services, notification services, social networking services, content (e.g., audio, video, images, etc.) provisioning services, application services, storage services, contextual information determination services, location-based services, information-based services (e.g., weather, news, etc.), and so forth. In one embodiment, the services platform 113 may use the output of the data analysis system 103 to localize the vehicle 105 or UE 109 (e.g., a portable navigation device, smartphone, portable computer, tablet, etc.), as well as other objects in a scenery, and provide services such as navigation, mapping, advertisement, other location-based services, and so forth.

The communication network 115 may include any number of networks, such as data networks, wireless networks, telephony networks, or combinations thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The map platform 101, data analysis system 103, vehicle 105, geographic database 107, UE 109, content provider 111, and services platform 113 may communicate with each other, and other components of the system 100, using various communication protocols. By way of example, protocols may include a set of rules defining how the network nodes within the communication network 115 interact with each other based on information and data sent over the communication links. The protocols may be effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information and data over a network are described in the Open Systems Interconnection (OSI) Reference Model.

Communications between the network nodes may be carried out by exchanging discrete packets of data. Each packet may comprise (1) header information associated with a particular protocol, and (2) payload information that follows the header information and contains information that may be processed independently of that particular protocol. In some protocols, the packet may include (3) trailer information following the payload and indicating the end of the payload information. The header may include information such as the source of the packet, its destination, the length of the payload, and other properties used by the protocol. The data in the payload for the particular protocol may include a header and payload for a different protocol associated with a different, higher layer of the OSI Reference Model. The header for a particular protocol may indicate a type for the next protocol contained in its payload. The higher layer protocol may be encapsulated in the lower layer protocol. The headers included in a packet traversing multiple heterogeneous networks, such as the Internet, may include a physical (layer 1) header, a data-link (layer 2) header, an internetwork (layer 3) header and a transport (layer 4) header, and various application (layer 5, layer 6 and layer 7) headers as defined by the OSI Reference Model.

Referring now to FIG. 1B, a schematic diagram of an example data analysis system 103, in accordance with aspects of the present disclosure, is illustrated. As shown, in some embodiments, the data analysis system 103 may include a number of input/output (I/O) module(s) 151, one or more processing modules 153, one or more memory module(s) 155, and possibly others. The modules can be implemented using various hardware, firmware, software, as described with reference to the map platform 101 in FIG. 1A. Alternatively, or additionally, modules may also be implemented as a cloud-based service, local service, native application, or combination thereof. Although the modules in FIG. 1B are shown as separate components of the data analysis system 103, it is contemplated that their respective functions may be readily combined into fewer modules, or further separated into more specialized modules.

The I/O module(s) 151 may include any combination of input and output elements for receiving and relaying various data and information. Example input elements may include a mouse, keyboard, touchpad, touchscreen, buttons, and other user interfaces configured for receiving various selections, indications, and operational instructions from a user. Input elements may also include various drives and receptacles, such as flash-drives, USB drives, CD/DVD drives, and other computer-readable medium receptacles, for receiving various data and information. Example output elements may include displays, touchscreens, speakers, LCDs, LEDs, and so on. In addition, I/O modules 151 may also include various communication hardware configured for exchanging data and information with various external computers, systems, devices, machines, mainframes, servers or networks, for instance.

As shown in FIG. 1B, the data analysis system 103 may include a number of processing modules 153 configured perform a variety of data processing and analysis. The processing module(s) 153 may process a variety of data and information received or accessed via the I/O module(s) 153, or from the memory module(s) 155, as well as from other systems and devices external to the data analysis system 103. The processing module(s) 153 may also provide processed data and information to respective modules of the data analysis system 103, and other systems and devices external to the data analysis system 103. For example, the processing module(s) 153 may be configured to determine one or more scores of digital maps and display to a user using the I/O module(s) 103 a digital map for navigation. In some implementations, the processing module(s) 153 may be configured to select a digital map with a highest score from a plurality of various map providers.

The geographic database 107 may include one or more memory modules 155 configured for storing and retrieving therefrom a variety of map data and information. In some embodiments, the memory module(s) 155 include non-volatile or non-transitory computer readable media, which may include instructions for carrying out steps in accordance with aspects of the present disclosure.

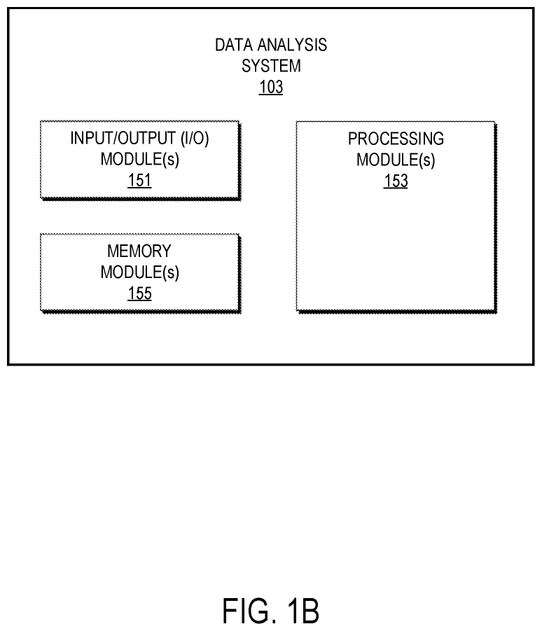

FIG. 2 is a diagram of an example digital map 200, in accordance with aspects of the present disclosure. The digital map 200 includes a speed limit sign 204 and a segment of a road 202. The segment of the road 202 includes lane markings 208. The segment of the road 202 includes a road boundary 215 that is defined by a first road divider 212 and a second road divider 214. One or more vehicles are intended to travel on the segment of the road 202 along a direction of travel 210. An area 206 encompasses the segment of the road 202 and the speed limit sign 204.

In one embodiment, an apparatus (e.g., data analysis system 103 of FIGS. 1A and 1B) may be configured to receive a score corresponding to the digital map 200. The apparatus may receive the score from one or more user devices (e.g., UE 109 of FIG. 1A), one or more vehicles (e.g., vehicle 105 of FIG. 1A), one or more platforms (e.g., map platform 101, services platform 113 of FIG. 1A), and one or more content providers (e.g., content provider 111a-n of FIG. 1A). In one example, the score corresponding to the digital map 200 may be based on the accuracy of map data in one or more areas of the digital map 200. For example, the apparatus may receive a score of 100% corresponding to the area 206 of the digital map 200. In this example, the score of 100% may be determined based on the accuracy of map data that includes the speed limit associated with the speed limit sign 204, the lane markings 208, and the road boundary 215 of the road 202 defined by the first road divider 212 and the second road divider 214. In one scenario, if there are changes in the real world to one or more aspects to the road 202 (e.g., a lane closure, construction work during a part of the year, etc.), then the accuracy of the map data may no longer be the same prior to the changes.

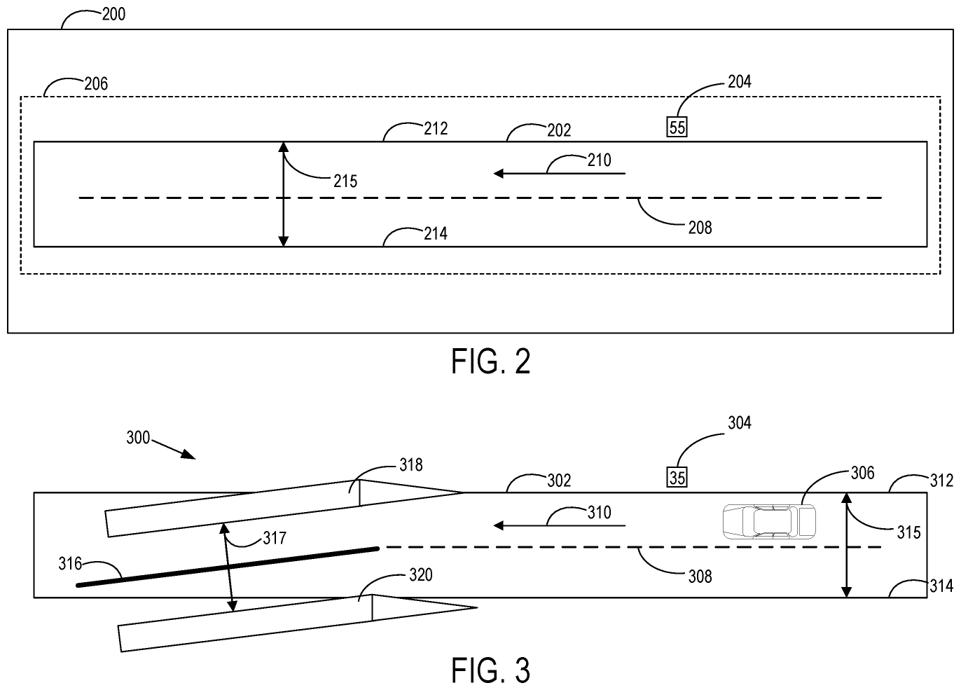

FIG. 3 is a diagram of an example scenario 300, in accordance with aspects of the present disclosure. The scenario 300 includes a speed limit sign 304 and a segment of a road 302. The segment of the road 302 includes lane markings 308 and lane markings 316. The segment of the road 302 includes a first road boundary 315 defined by a first road divider 312 and a second road divider 314. The segment of the road 302 includes a second road boundary 317 defined by a third road divider 318 and a fourth road divider 320. A vehicle 306 is intended to travel on the segment of the road 302 along a direction of travel 310.

In one example, the diagram of the scenario 300 corresponds to the digital map 200 of FIG. 2. In one scenario, one or more aspects of the segment of the road 302 has been changed due to construction work surrounding the road 302. In this scenario, as shown in FIG. 3, as the vehicle 306 travels along the road 302, the vehicle 306 will need to move away from the road boundary 315 and stay within a new road boundary 317 based on the presence of the third road barrier 318 and the fourth road barrier 320. Further, the vehicle 306 will need to adhere to the new lane markings 316 that serve as a guide through the road boundary 317. Continuing with this scenario, to facilitate the safe passage of the vehicle 306 through the road boundary 317, the speed limit associated with the speed limit sign 304 has been decreased from 55 miles per hour (MPH) to 35 MPH. In this scenario, the digital map 200 no longer accurately reflects the one or more changes to the segment of the road 202.

To address this scenario, in one embodiment, the apparatus is configured to receive data captured via at least one or more sensors of the vehicle 306 as the vehicle travels along the road 302. The data captured via the one or more sensors corresponds to the digital map 200. In one example, the apparatus is configured to determine a revised score corresponding to the digital map 200 based on the data captured via the at least one or more sensors of the vehicle 306 and map data of the digital map 200. In one example, the map data includes the speed limit corresponding to the speed limit sign 204, the road boundary 215 of the road 202 as defined by the first road barrier 212 and the second road barrier 214, and the lane markings 208. Continuing with this example, the apparatus is configured to update the score of the digital map 200 based on the revised score.

In one example, the data captured via the at least one or more sensors of the vehicle 306 is image data. In this example, the apparatus is configured to decrease the score by a predetermined amount based on one or more determined differences between the image data captured via the at least one or more sensors of the vehicle 306 and the map data of the digital map 200. For example, the apparatus may be configured to determine a difference of 20 MPH between the speed limit of 35 MPH corresponding to the speed limit sign 304, based on image data captured via the at least one or more sensors of the vehicle 306, and the speed limit of 55 MPH corresponding to the speed limit sign 204, based on the map data of the digital map 200. In this example, the difference of 20 MPH may correspond to a predetermined decrease of 10% and therefore the apparatus may be configured to update the score to 90% for the digital map 200. By way of example, the speeds limits captured via the sensors of the vehicle 306 may be captured at one or more locations that correspond to the digital map 200.

In another embodiment, the apparatus may be configured determine a difference in the lane markings 316 captured via the at least one or more sensors of the vehicle 306 and the lane markings 208 based on the map data of the digital map 200. In this example, the apparatus may be configured to determine if there are changes to the lanes based on they type of lane markings, the angle of the lane markings, or other attributes of lane markings that are associated with driving requirements in a given jurisdiction. For example, the apparatus may determine that the lane markings 316 are in a different direction from the lane markings 208. Further, the apparatus may also determine that lane markings 316 are intended to prohibit lane changes compared to the intended use of the lane markings 208. In this example, a determined difference in direction and intended use of lane markings may correspond to a predetermined decrease of 25% and therefore the apparatus may be configured to update the score from 90% to 65% for the digital map 200. By way of example, the one or more lane markings captured via the at least one or more sensors of the vehicle 306 may be captured at one or more locations corresponding to the digital map 200.

In one embodiment, the apparatus may be configured to determine a difference in the third road divider 318 and the fourth road divider 320 captured via the at least one or more sensors of the vehicle 306 and one or more road dividers 212 and 214 based on the map data of the digital map 200. For example, the apparatus may be configured to determine any number of changes to the road such as whether any lanes of a road are closed, the road boundary, or if there are one or more changes in a direction of travel associated with the road. Referring to FIG. 3, the apparatus may be configured to determine a change in the round boundary 317 compared to the road boundary 315. Further the apparatus may be configured to determine a different direction of travel through the road boundary 317 compared to the direction of travel 210 associated with the road boundary 215. In this example, a determined difference in the road boundary and the direction of travel may correspond to a predetermined decrease of 30% and therefore the apparatus may be configured to update the score from 65% to 35% for the digital map 200. By way of example, the one or more road dividers captured via the at least one or more sensors of the vehicle 306 may be captured at one or more locations corresponding to the digital map 200.

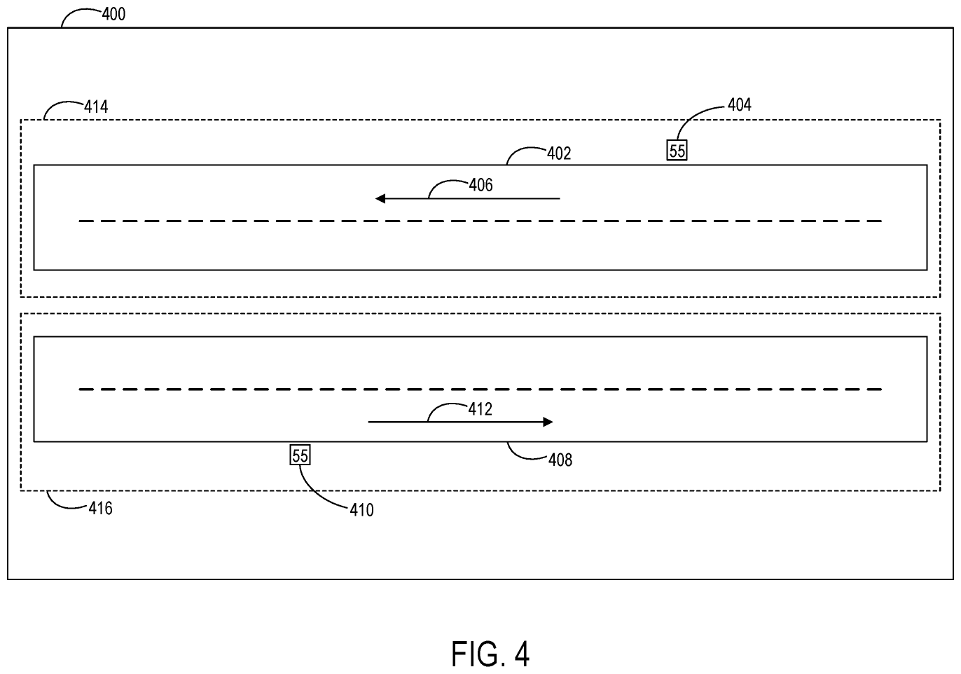

FIG. 4 is a diagram of an example digital map 400, in accordance with aspects of the present disclosure. The digital map 400 includes a segment of a road 402 and a speed limit sign 404. One or more vehicles are intended to travel on the segment of the road 402 along a direction of travel 406. An area 414 encompasses the segment of the road 402 and the speed limit sign 404. The digital map 400 also includes a segment of a road 408 and a speed limit sign 410. One or more vehicles are intended to travel on the segment of the road 410 along a direction of travel 412. An area 416 encompasses the segment of the road 402 and the speed limit sign 404.

In one embodiment, an apparatus may be configured to receive a first score corresponding to the area 414 and a second score corresponding to the area 416. In this embodiment, the apparatus may be configured to determine an overall score for the digital map 400 based on a combination of the first score and the second score. In one example, the area 414 may have a score of 80% and the area 416 may be have a score of 90%. In this example, the apparatus may determine an overall score of 85% for the digital map 400 based on an average of the scores corresponding to the area 414 and the area 416. It is also envisioned that the determination of the score of a digital map based on the scores of multiple areas of the digital map can be determined in various other ways.

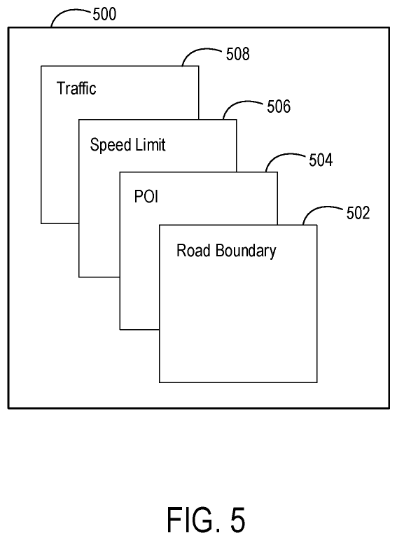

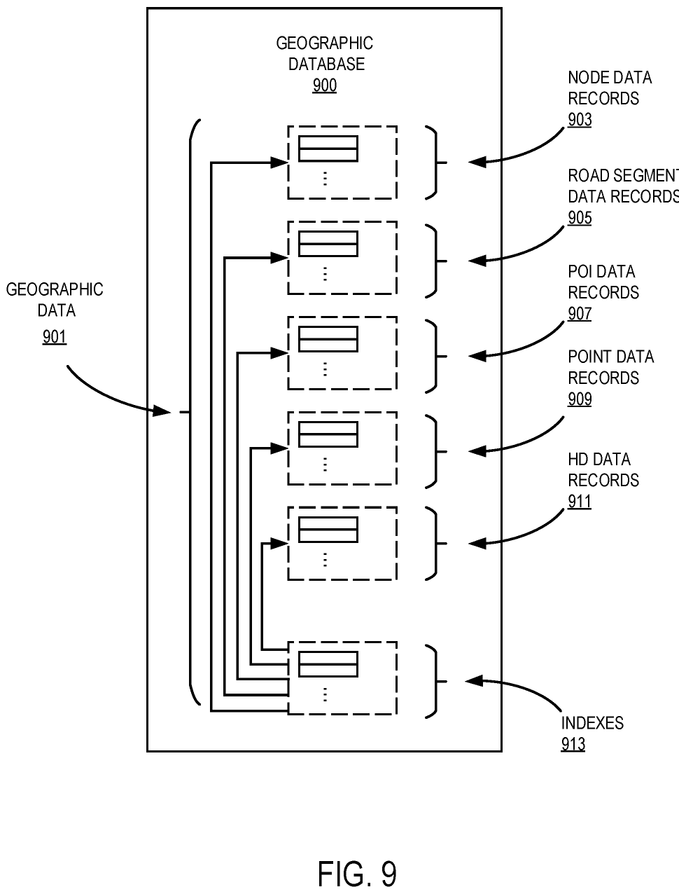

In another embodiment, the apparatus may be configured to receive a score corresponding to a digital map that is based on a plurality of scores corresponding to a plurality of layers of the digital map. For example, FIG. 5 is an example diagram of a digital map 500. The digital map 500 includes a road boundary layer 502, a point of interest (POI) layer 504, and a speed limit layer 506, and a traffic layer 508. Each of the layers includes map data corresponding to the digital map 500. By way of example, each of the layers in the digital map 500 may include data from node data records 903, road segment data records 905, POI data records 907, point data records 909, and HD Data Records 911 of FIG. 9, as described below.

In one example, the apparatus may be configured to determine one or more differences in data captured via the at least one or more sensors of a vehicle and data corresponding to the road boundary layer 502. Continuing with this example, the apparatus may be configured to update the score of the digital map based on the difference in the data captured and the map data corresponding to road boundary layer 502. In one scenario, the road boundary layer score may be decreased from 100% to 70% based on the determined one or more differences in the data captured via the at least one or more sensors of the vehicle and the map data corresponding to the road boundary layer 502. In this scenario, the apparatus may update a score of the digital map 500 based on the decreased score of the road boundary layer 502.

In another example, the apparatus may be configured to determine one or more differences in data captured via the at least one or more sensors of a vehicle and data corresponding to the POI layer 504. Continuing with this example, the apparatus may be configured to update the score of the digital map 500 based on the difference in the data captured and the map data corresponding to the POI layer 504. In one scenario, the POI layer score may be decreased from 100% to 80% based on the determined one or more differences in the data captured via the at least one or more sensors of the vehicle and the map data corresponding to the POI layer 504. In this scenario, the apparatus may update a score of the digital map 500 based on the decreased score of the POI layer 504.

In one example, the apparatus may be configured to determine one or more differences in data captured via the at least one or more sensors of a vehicle and data corresponding to speed limit layer 506. Continuing with this example, the apparatus may be configured to update the score of the digital map based on the differences in the data captured and the map data corresponding to the speed limit layer 506. In one scenario, the speed limit layer score may be decreased from 100% to 60% based on the determined one or more differences in the data captured via the at least one or more sensors of the vehicle and the map data corresponding to the speed limit layer 506. In this scenario, the apparatus may update a score of the digital map 500 based on the decreased score of the speed limit layer 506.

In another example, the apparatus may be configured to determine one or more differences in data captured via the at least one or more sensors of a vehicle and data corresponding to the traffic layer 508. Continuing with this example, the apparatus may be configured to update the score of the digital map based on the differences in the data captured and the map data corresponding to the traffic layer 508. In one scenario, the traffic layer score may be decreased from 100% to 90% based on the determined one or more differences in the data captured via the at least one or more sensors of the vehicle and the map data corresponding to the traffic layer 508. In this scenario, the apparatus may update a score of the digital map 500 based on the decreased score of the traffic layer 508.

In one embodiment, the apparatus may be configured to determine an overall score for the digital map 500 based on the scores of each of the layers of the digital map 500. In one example, the apparatus may receive a score of 70 corresponding to the road boundary layer 502, a score of 80 corresponding to the POI layer 504, score of 60 corresponding to the speed limit layer 506, and a score of 90 corresponding to the traffic layer 508. In this example, the apparatus may determine a score of 75 for the digital map 500 based on an average of all the scores of the layers. In one scenario, one or more layers may be weighted more than other layers when determining the score of the digital map 500. In another scenario, the apparatus is configured to determine a score for the digital map 500 in real-time based on one or more changes in scores corresponding to data captured by one or more sensor of one or more vehicles.

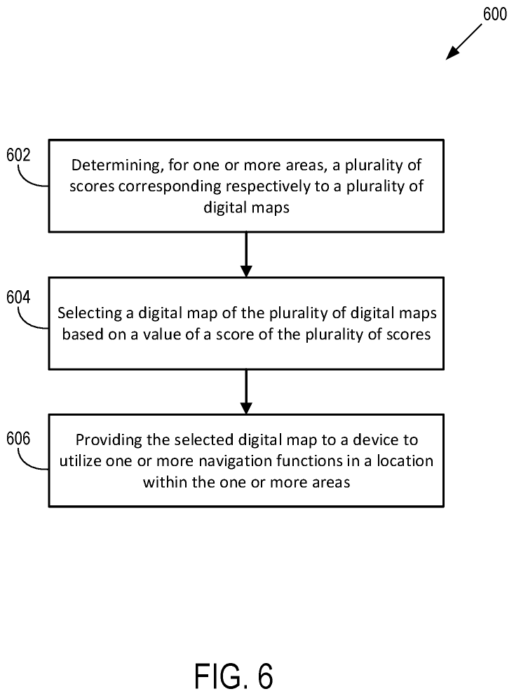

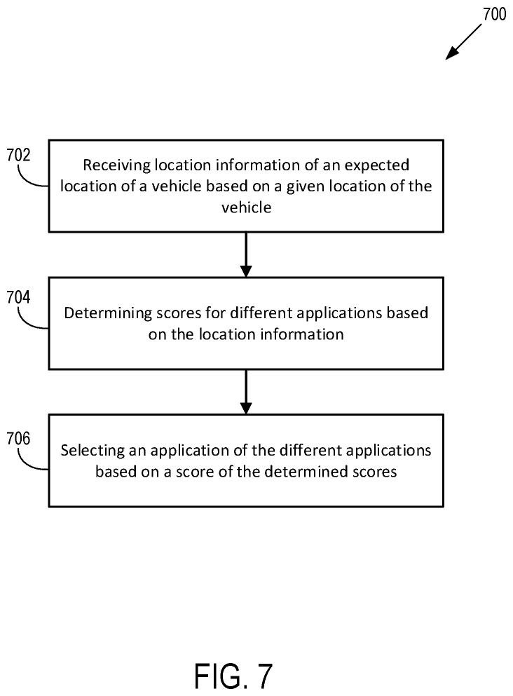

FIGS. 6 and 7 are flow diagrams of example methods for selecting a navigation map for utilization in a region, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 6 and 7 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 6 or FIG. 7 may represent circuitry that is wired to perform the specific logical functions in the process. Illustrative methods, such as those shown in FIGS. 6 and 7, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIG. 6 or FIG. 7 may be fully performed by a computing device (or components of a computing device such as one or more processors), or may be distributed across multiple components of the computing device, across multiple computing devices, and/or across a server.

Referring first to FIG. 6, an example method 600 of selecting a navigation map for utilization in a region may include one or more operations, functions, or actions as illustrated by blocks 602-606. The blocks 602-606 may be repeated periodically or performed intermittently, or as prompted by a user, device or system. In one embodiment, the method 600 is implemented in whole or in part by the data analysis system 103 of FIG. 1B.

As shown by block 602, the method 600 includes determining, for one or more areas, a plurality of scores corresponding respectively to a plurality of digital maps. In one embodiment, an apparatus is configured to partition the one or more areas corresponding respectively to the plurality of the digital maps.

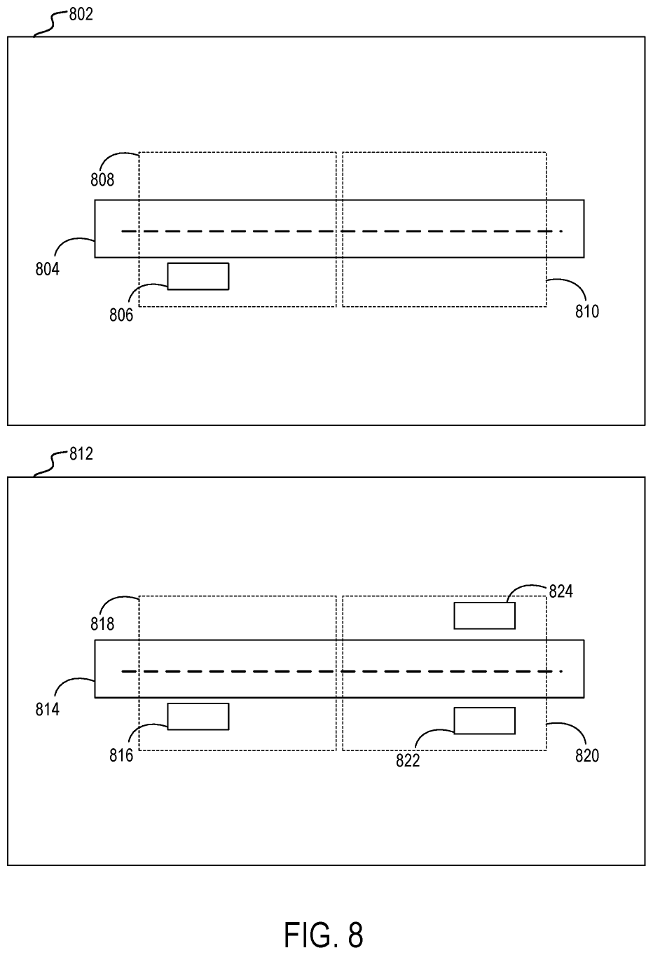

FIG. 8 is a diagram of an example digital map 802 and an example digital map 812, in accordance with aspects of the present disclosure. The digital map 802 includes a segment of a road 804 and a point of interest 806. An area 808 encompasses a segment of the road 804 and the point of interest 806. An area 810 encompasses a segment of the road 804. The digital map 812 includes a segment of a road 814, a point of interest 816, a point of interest 822, and a point of interest 824. An area 818 encompasses a segment of the road 804 and the point of interest 816. An area 820 encompasses a segment of the road 814, the point of interest 822, and the point of interest 824.

In one example, the digital map 802 corresponds to a first map provider and the digital map 812 corresponds to a second map provider. In one example, an apparatus may be configured to determine a score for the area 808 and the area 810 corresponding to the digital map 802. In this example, the apparatus may also be configured to determine a score for the area 818 and the area 820 corresponding to the digital map 812. In one scenario, the apparatus may determine the same score for areas 808 and 818 based on the same point of interest represented by the point of interest 806 and the point of interest 816. Continuing with this scenario, the apparatus may determine a higher score for the area 820 compared to a score for the area 810 based on the additional points of interest represented by the point of interest 822 and the point of interest 824. The additional points of interest may be represented on the digital map 812 based on the second map provider updating the digital map 812 according to developments corresponding to real world locations associated with those points of interest. In another example, the plurality of scores corresponding respectively to the plurality of digital maps are based on a plurality of scores of a plurality of layers of the plurality of digital maps.

In one embodiment, the one or more areas of the digital map 802 can be geographic points (e.g., nodes or other location points, a latitude and a longitude, geographic coordinates), map tiles, road links or segments, intersections, points of interests (POIs), and/or any other map feature represented in a geographic database (e.g., the geographic database 107 of FIG. 1A). In one embodiment, one geographic point can be used to represent a geographic area such as a map tile or any other geographic boundary. Accordingly, the one geographic point can be a centroid or reference point(s) within the area. For example, in the case of a map tile of a tile-based representation of a geographic database (e.g., the geographic database 107 of FIG. 1A), the one geographic point can be a centroid of the tile, and the geographic area represented by the at least one geographic point is an area represented by the tile.

Referring back to FIG. 6, as shown by block 604, the method 600 also includes selecting a digital map of the plurality of digital maps based on a value of a score of the plurality of scores. In one example, the digital map is selected from the plurality of digital maps based on an overall score of the digital map. In another example, the digital map is selected from the plurality of digital maps based on a score corresponding to one or more areas of the digital map. In another example, the digital map is selected from the plurality of digital maps based on a score corresponding to one or more layers of the digital map.

As shown by block 606, the method 600 also includes providing the selected digital map to a device to utilize one or more navigation functions in a location within the one or more areas. In one example, the selected digital map may be provided to a user device (e.g., UE 109 of FIG. 1). In another example, the selected digital map be provided to a vehicle (e.g., vehicle 105 of FIG. 1). In this example, an account associated with the vehicle may be part of a subscription that provides access to a plurality of digital maps corresponding to a plurality of map providers. Continuing with this example, the account of the vehicle may be associated with user preferences that serve as inputs when deciding which digital map to utilize for navigational functions. For example, a preference associated with the account may request access to the most updated map regarding any restaurants in a given area. In this example, a digital map from the plurality of digital maps may be selected based on the highest score corresponding to a points of interest layer.

In another example, the selection of a digital map based on the score of the digital map may occur within an autonomous vehicle. In one embodiment, the autonomous vehicle may be configured to automatically select different maps from different providers without passengers of the autonomous vehicle being aware of the selection and/or the utilization of the different maps. For example, the autonomous vehicle may not include a user interface that displays a map. In another example, the selection of the different maps from the different map providers may be done in the background so that audio or visual programming that is playing within the autonomous vehicle is not interrupted by the selection of different maps.

The method 600 may further include receiving data captured via one or more sensors of a vehicle. In this example, the data captured via the one or more sensors corresponds to the one or more areas that are associated with the determined score. The method 600 may further include determining a second score based on the data captured via the one or more sensors of the vehicle and map data of the selected digital map. In one scenario, the determined second score of an area may be lower than a determined first score of the area. The method 600 may further include updating the score of the selected digital map based on the second score.

The method 600 may further include comparing the updated score of the selected digital map to a threshold. The method 600 may further include, based on the updated score satisfying the threshold, selecting a second digital map of the plurality of digital maps and providing the second digital map to the device. In one example, the device may be the UE 109 of FIG. 1A. In this example, an account corresponding to the UE 109 may be part of a subscription that provides access to a plurality of digital maps corresponding to a plurality of map providers. Continuing with this example, the account corresponding to the UE 109 may be associated with user preferences that serve as inputs when deciding which digital map to utilize for navigational functions. For example, a preference associated with the account may request access to the most updated map regarding traffic data in a given area. In this example, a digital map from the plurality of digital maps may be selected based on the highest score corresponding to a traffic layer.

The method 600 may further include receiving a review score via an input of the device. The review score corresponds to the one or more areas. For example, a passenger may provide a review of a portion of a trip within a vehicle via a user device such as the UE 109. In another example, a user may provide the review via one or more input devices coupled to a vehicle. The method 600 may further include determining a revised score based on the review score and updating the score of the selected digital map based on the revised score.

Referring to FIG. 7, the example method 700 may include one or more operations, functions, or actions as illustrated by blocks 702-706. The blocks 702-706 may be repeated periodically or performed intermittently, or as prompted by a user, device or system. In one embodiment, the method 700 is implemented in whole or in part by the data analysis system 103 of FIG. 1B.

As shown by block 702, the method 700 includes receiving location information of an expected location of a vehicle based on a given location of the vehicle. In one example, a vehicle may be expected to arrive at a destination shortly. In this example, the location information of the expected location may be the address of a hotel with a parking structure. Continuing with this example, there may be a different application that is more suited to navigating the parking structure of the hotel compared to a current application in use within a vehicle.

As shown by block 704, the method 700 also includes determining scores for different applications based on the location information. In one example, the different applications may include an application for navigation across rural areas and a second application for navigation in cities. In this example, the application for navigation across rural areas may score lower in one or more areas compared to one or more areas of the application for navigation in cities.

As shown by block 706, the method 700 also includes selecting an application of the different applications based on a score of the determined scores. In one example, a system for navigation of a vehicle may have access to a plurality of applications corresponding to a plurality of map providers. Continuing with this example, an apparatus may select an application from the plurality of applications for the vehicle to navigate an area based on a score of the selected application. For example, an application may have a higher score than other applications based on the application being directed to locating the most inexpensive parking location. In this example, the apparatus may provide this application to a vehicle as the vehicle approaches a predetermined destination. In one example, a company may create a digital map using a certain methodology and/or data format while a second company may map the same area using a different methodology and/or data format. Continuing with this example, a device (e.g., UE 109 of FIG. 1A) or a device associated with a vehicle (e.g., vehicle 105 of FIG. 1A) may include a universal interface or application that can switch between different company maps in an agnostic manner rather than having to select different applications.

The method 700 may further include receiving data captured via at least one or more sensors of at least one other vehicle. In one example, the data captured via the at least one or more sensors corresponds to a selected application. In this example, method 700 may further include determining a revised score based on the data captured via the at least one or more sensors of the at least one other vehicle. The method 700 may further include updating the score of the selected application based on the revised score.

The method 700 may further include comparing the score of the application to a threshold. The method 700 may further include, based on satisfying the threshold, selecting another application of the different applications. In one example, the score of the application may change in real-time. For example, one or more other vehicles may provide sensor data that corresponds to the application and that results in a decreased score of the application. In this example, the method 700 may determine that another application may be better suited for utilization over the currently selected application.

The method 700 may further include receiving a review score via an input within the vehicle. In one example, the review score corresponds to the application. The method 700 may further include determining a revised score based on the review score. The method 700 may further include updating the score of the application based on the revised score.

Turning now to FIG. 9, a diagram of a geographic database 900, according to aspects of the present disclosure, is shown. As shown, the geographic database 900 may include a variety of geographic data 901 tabulated in various arrangements and used in various applications. For example, the geographic data 901 may be used for (or configured to be compiled to be used for) mapping and/or navigation-related services. As shown in FIG. 9, the geographic data 901 may include node data records 903, road segment data records 905, point of interest (POI) data records 907, point data records 909, high definition (HD) mapping data records 911, and indexes 913, for example. The geographic data 901 may include more, fewer or different data records. In some embodiments, additional data records (not shown in FIG. 9) may also be included, such as cartographic (“carto”) data records, routing data records, maneuver data records, and other data records.

In particular, the HD mapping data records 911 may include a variety of data, including data with resolution sufficient to provide centimeter-level or better accuracy of map features. For example, the HD mapping data may include data captured using LiDAR, or equivalent technology capable large numbers of 3D points, and modelling road surfaces and other map features down to the number lanes and their widths. In one embodiment, the HD mapping data (e.g., HD data records 911) capture and store details such as the slope and curvature of the road, lane markings, roadside objects such as signposts, including what the signage denotes. By way of example, the HD mapping data enable highly automated vehicles to precisely localize themselves on the road.

In some implementations, geographic features (e.g., two-dimensional or three-dimensional features) may be represented in the geographic database 900 using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 900:

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In some implementations, certain conventions or rules may be followed in the geographic database 900. For example, links may not cross themselves or each other except at a node. In another example, shape points, nodes, or links may not be duplicated. In yet another example, two links that connect each other may have a common node. In the geographic database 900, overlapping geographic features are represented by overlapping polygons. When polygons overlap, the boundary of one polygon crosses the boundary of the other polygon.

In the geographic database 900, the location at which the boundary of one polygon intersects the boundary of another polygon may be represented by a node. In one embodiment, a node may be used to represent other locations along the boundary of a polygon than a location at which the boundary of the polygon intersects the boundary of another polygon. In one embodiment, a shape point may not be used to represent a point at which the boundary of a polygon intersects the boundary of another polygon.

In exemplary embodiments, the road segment data records 905 may be links or segments representing roads, streets, or pathways, as can be used in the calculated route or recorded route information for determination of one or more personalized routes. The node data records 903 may be end points (such as intersections) corresponding to the respective links or segments of the road segment data records 905. The road link data records 905 and the node data records 903 may represent a road network, as used by vehicles, cars, and/or other entities, for instance. Alternatively, the geographic database 900 may contain pathway segment and node data records or other data that represent pedestrian pathways or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 900 can include data about the POIs and their respective locations in the POI data records 907. The geographic database 900 can also include data about places, such as cities, towns, or other communities, and other geographic features, such as bodies of water, mountain ranges, etc. Such place or feature data can be part of the POI data records 907 or can be associated with POIs or POI data records 907 (such as a data point used for displaying or representing a position of a city).

As shown in FIG. 9, the geographic database 900 may also include point data records 909 for storing the point data, map features, as well as other related data used according to the various embodiments described herein. In addition, the point data records 909 can also store ground truth training and evaluation data, machine learning models, annotated observations, and/or any other data. By way of example, the point data records 909 can be associated with one or more of the node records 903, road segment records 905, and/or POI data records 907 to support verification, localization or visual odometry based on the features stored therein and the corresponding estimated quality of the features. In this way, the records 909 can also be associated with or used to classify the characteristics or metadata of the corresponding records 903, 905, and/or 907.

As discussed above, the HD mapping data records 911 may include models of road surfaces and other map features to centimeter-level or better accuracy. The HD mapping data records 911 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD mapping data records 911 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD mapping data records 911 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD mapping data records 911.

In one embodiment, the HD mapping data records 911 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The geographic database 900 may be maintained by content provider in association with a services platform (e.g., a map developer), as described with reference to FIG. 1A. The map developer can collect geographic data to generate and enhance the geographic database 107. The data may be collected in various ways by the map developer, including obtaining data from other sources, such as municipalities or respective geographic authorities. In addition, the map developer can employ field personnel to travel by vehicle along roads throughout the geographic area of interest to observe features and/or record information about them, for example. Also, remote sensing, such as aerial or satellite photography, can be used.

In some implementations, the geographic database 900 can be a master geographic database stored in a format that facilitates updating, maintenance, and development. For example, the master geographic database or data in the master geographic database can be in an Oracle spatial format or other spatial format, such as for development or production purposes. The database or records thereof may be provided as map data layers. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device of a vehicle, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The indexes 913 in FIG. 9 may be used improve the speed of data retrieval operations in the geographic database 107. Specifically, the indexes 913 may be used to quickly locate data without having to search every row in the geographic database 900 every time it is accessed. For example, in one embodiment, the indexes 913 can be a spatial index of the polygon points associated with stored feature polygons.

In one embodiment, the geographic database 900 is presented according to a hierarchical or multi-level tile projection. More specifically, in one embodiment, the geographic database 900 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, a system (e.g., the system 100 of FIG. 1A) may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one dimensional array of the quadkey. In another example, the length of the one dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

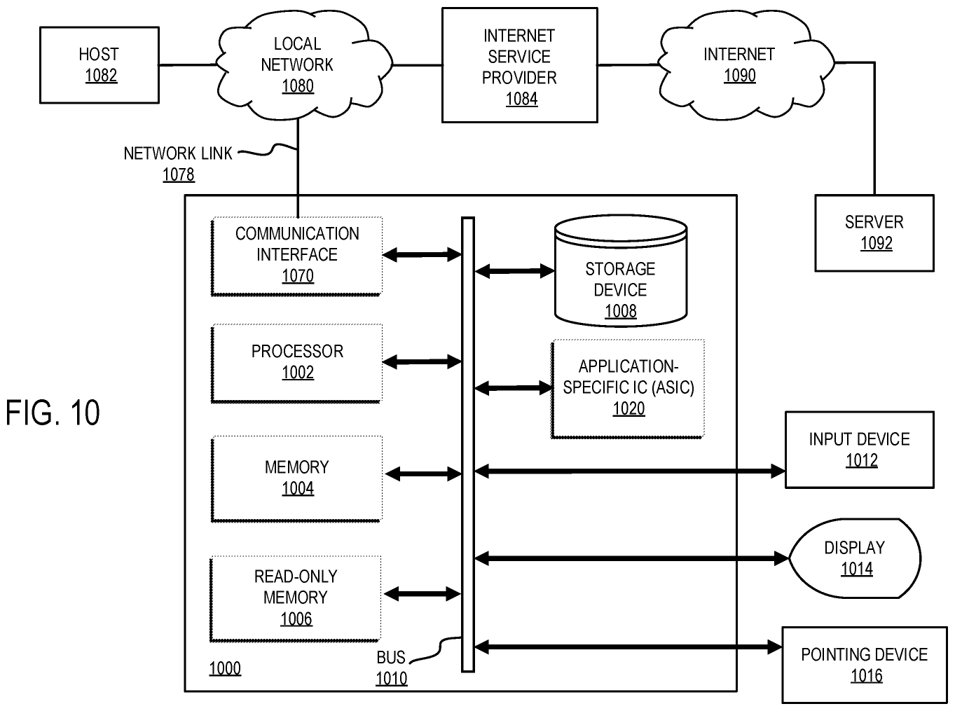

Turning now to FIG. 10, an example computer system 1000, in accordance with aspects of the present disclosure, is illustrated in FIG. 10. The computer system 1000 may be programmed (e.g., via computer program code or instructions) to perform a variety of steps, including steps for synchronization, in accordance with methods described herein.

As shown in FIG. 10, the computer system 1000 may generally include a processor 1002, which may be configured to perform a set of operations on information as specified by computer program code. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). In some aspects, the set of operations may include bringing information in from a bus 1010 and placing information on the bus 1010. The set of operations may also include comparing two or more units of information, shifting positions of units of information, and combining two or more units of information, such as by addition or multiplication or logical operations like OR, exclusive OR (XOR), and AND. Each operation of the set of operations performed by the processor 1002 may be represented to the processor 1002 by information called instructions, such as an operation code of one or more digits. The sequence of operations to be executed by the processor 1002, such as a sequence of operation codes, constitute processor 1002 instructions, may also be called computer system 1000 instructions or, simply, computer instructions. The processor 1002 may include multiple processors, units or modules, and may be implemented as mechanical, electrical, magnetic, optical, chemical or quantum components, among others, or any combination thereof.

As shown in FIG. 10, the computer system 1000 may also include a memory 1004 coupled to bus 1010. The memory 1004, such as a random-access memory (RAM) or other dynamic storage device, may be configured to store a variety of information and data, including processor instructions for carrying steps in accordance with aspects of the disclosure. Dynamic memory allows information stored therein to be changed by the computer system 1000. The RAM allows a unit of information stored at a location called a memory address to be stored and retrieved independently of information at neighboring addresses. The memory 1004 may also be used by the processor 1002 to store temporary values during execution of processor instructions.

The computer system 1000 may also include a read-only memory (ROM) 1006, or other static storage device, coupled to the bus 1010. The ROM 1006 may be configured for storing static information, including instructions, that is not changed by the computer system 1000. Some memory 1004 includes volatile storage that loses the information stored thereon when power is lost. Also coupled to bus 1010 is a non-volatile (persistent) storage device 908, such as a magnetic disk, optical disk or flash card, for storing information, including instructions, that persists even when the computer system 1000 is turned off or otherwise loses power.

As mentioned, the bus 1010 may be configured for passing information and data between internal and external components of the computer system 1000. To do so, the bus 1010 may include one or more parallel conductors that facilitate quick transfer of information and data among the components coupled to the bus 1010. The information and data may be represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, may represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, analog data may be represented by a near continuum of measurable values within a particular range.

Information, including instructions for synchronization, may be provided to the bus 1010 for use by the processor 1002 from an external input device 1012, such as a keyboard or other sensor. The sensor may be configured to detect conditions in its vicinity and transform those detections into physical expression compatible with the measurable phenomenon used to represent information in computer system 1000. Other external devices coupled to bus 1010, used primarily for interacting with humans, may include a display device 1014, such as a cathode ray tube (CRT) or a liquid crystal display (LCD), or plasma screen or printer for presenting text or images, as well as a pointing device 1016 (e.g., a mouse, trackball, cursor direction keys, motion sensor, etc.) for controlling a position of a small cursor image presented on the display 1014 and issuing commands associated with graphical elements presented on the display 1014. In some embodiments, for example, the computer system 1000 performs all functions automatically without human input. As such, one or more of external input device 1012, display device 1014 and pointing device 1016 may be omitted.

As shown in FIG. 10, special purpose hardware, such as an application specific integrated circuit (ASIC) 1020, may be coupled to bus 1010. The special purpose hardware may be configured to perform specialized operations. Examples of ASICs include graphics accelerator cards for generating images for display 1014, cryptographic boards for encrypting and decrypting messages sent over a network, speech recognition, and interfaces to special external devices.

The computer system 1000 may also include one or more instances of a communications interface 1070 coupled to bus 1010. The communication interface 1070 may provide a one-way or two-way communication coupling to a variety of external devices that operate with their own processors, such as printers, scanners and external disks. In addition, the communication interface 1070 may provide a coupling to a local network 1080, by way of a network link 1078. The local network 1080 may provide access to a variety of external devices and systems, each having their own processors and other hardware. For example, the local network 980 may provide access to a host 1082, or an internet service provider 1084, or both, as shown in FIG. 10. The internet service provider 1084 may then provide access to the Internet 1090, in communication with various other servers 1092.

By way of example, the communication interface 1070 may include a parallel port or a serial port or a universal serial bus (USB) port on a personal computer. In some embodiments, the communications interface 1070 may include one or more integrated services digital network (ISDN) cards, or digital subscriber line (DSL) cards, or telephone modems that provides an information communication connection to a corresponding type of telephone line. In some embodiments, the communication interface 1070 may include a cable modem that converts signals on bus 1010 into signals for a communication connection over a coaxial cable or into optical signals for a communication connection over a fiber optic cable. As another example, the communications interface 1070 may be a local area network (LAN) card configured to provide a data communication connection to a compatible LAN, such as Ethernet. Wireless links may also be implemented. For wireless links, the communications interface 1070 may send and/or receive electrical, acoustic or electromagnetic signals, including infrared and optical signals, that carry information streams, including digital data. For example, in wireless handheld devices (e.g., mobile telephones, cell phones, and so forth), the communications interface 1070 may include a radio band electromagnetic transmitter and receiver called a radio transceiver. In certain embodiments, the communications interface 1070 enables connection to the communication network, as described with reference to FIG. 1A.

As used herein, computer-readable media refers to any media that participates in providing information to processor 1002, including instructions for execution. Such media may take many forms, and include non-volatile media, volatile media, transmission media, and others. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

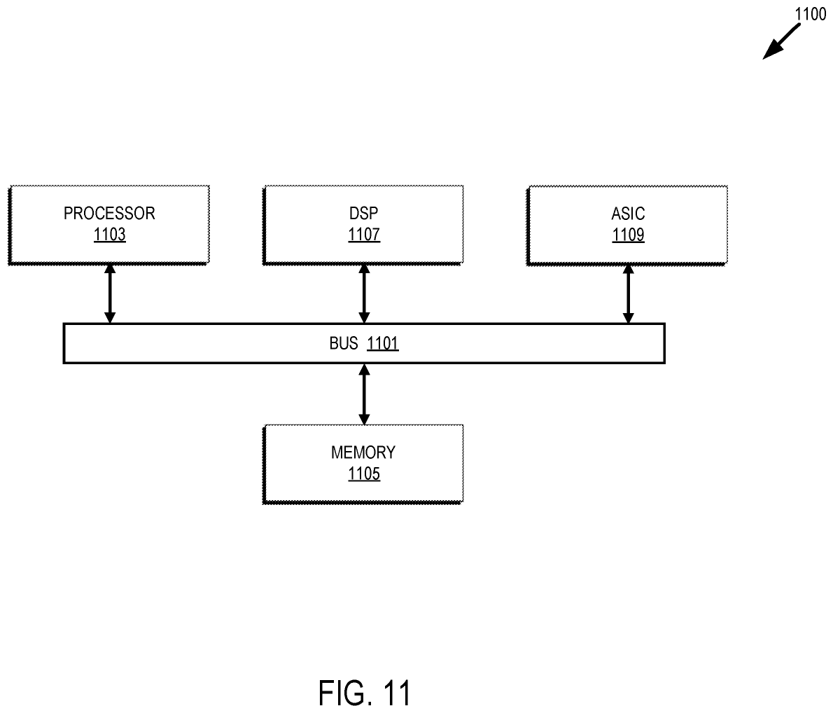

Turning now to FIG. 11, a chip set 1100, in accordance with aspects of the present disclosure, is illustrated. In some implementations, the chip set 1100 may be programmed to carry out steps in accordance with methods described herein, and may include various components (e.g., as described with respect to FIG. 10) incorporated in one or more physical packages (e.g., chips). By way of example, a physical package includes an arrangement of one or more materials, components, and/or wires on a structural assembly (e.g., a baseboard) that provides one or more characteristics, such as physical strength, conservation of size, and/or limitation of electrical interaction. It is contemplated that in certain embodiments the chip set 1100 can be implemented in a single chip.

As shown, the chip set 1100 may include a communication mechanism, such as a bus 1101 for passing information and data among the components of the chip set 1100. A processor 1103 connected to the bus 1101 may be configured to execute instructions and process information stored in, for example, a memory 1105. The processor 1103 may include one or more processing cores, with each core capable of performing independently. In some implementations, a multi-core processor may be used, which enables multiprocessing within a single physical package. Examples of a multi-core processor include two, four, eight, or greater numbers of processing cores. Alternatively, or additionally, the processor 1103 may include one or more microprocessors configured in tandem, via the bus 1101, to perform independent execution of instructions, pipelining, and multithreading.

The chip set 1100 may also include specialized components configured to perform certain processing functions and tasks. For instance, the chip set 1100 may include one or more digital signal processors (DSP) 1107, or one or more application-specific integrated circuits (ASIC) 1109, or both. In particular, the DSP 1107 may be configured to process real-world signals (e.g., sound) in real time independently of the processor 1103. Similarly, the ASIC 1109 may be configured to performed specialized functions not easily performed by a general-purpose processor. Other specialized components to aid in performing the inventive functions described herein may include one or more field programmable gate arrays (FPGA) (not shown), one or more controllers (not shown), or one or more other special-purpose computer chips.

The processor 1103 and accompanying components may have connectivity to the memory 1105 via the bus 1101, as shown. The memory 1105 may include dynamic memory (e.g., RAM, magnetic disk, writable optical disk, etc.), static memory (e.g., ROM, CD-ROM, etc.), and others, configured for storing executable instructions. The instructions, when executed, perform a variety of steps, including steps for identifying the quality of terrestrial data, in accordance with methods described herein. The memory 1105 may also store the data associated with or generated by the execution.

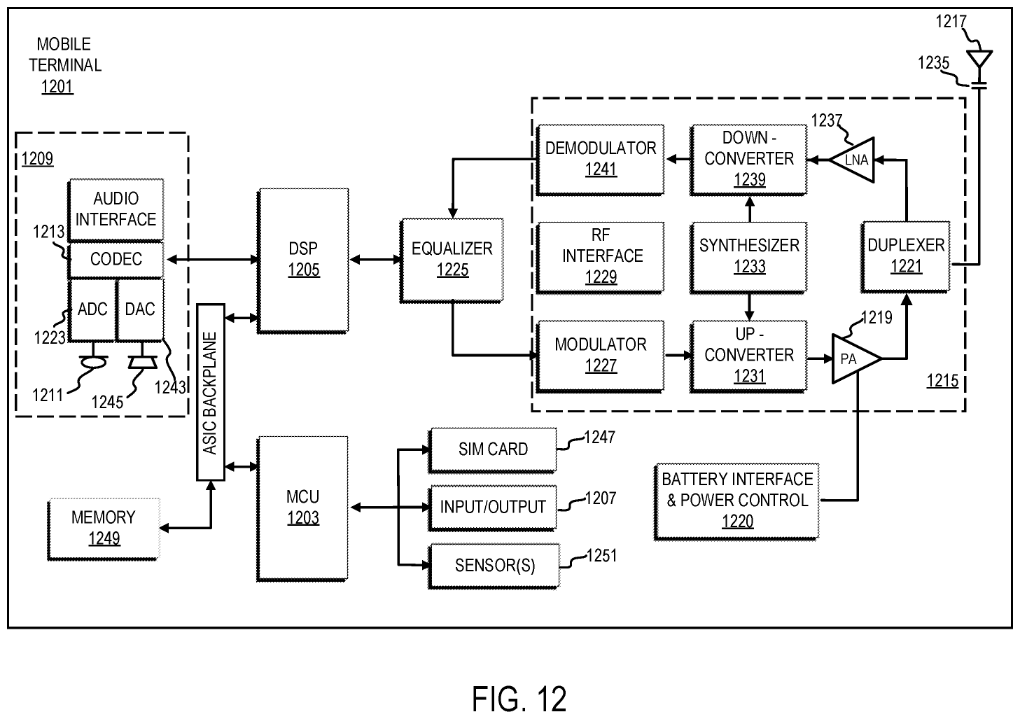

Turning now to FIG. 12, a diagram of example mobile terminal 1201 (such as a mobile device or vehicle or part thereof), in accordance with aspects of the present disclosure, is shown. In some implementations, the mobile terminal 1201 may be a handhold cellular phone, smart phone, tablet, and so forth. Alternatively, the mobile terminal 1201 may be an embedded component of the vehicle 105 or UE 109, as described with reference to FIG. 1A.

In general, the mobile terminal 1201 may include a Main Control Unit (MCU) 1203, a Digital Signal Processor (DSP) 1205, a number of input/output components 1207. In some configurations, input/output components 1207 (e.g., a display, touchscreen, keyboard, etc) are configured to provide feedback to user in support of various applications and functions of the mobile terminal 1201. The mobile terminal 1201 may also include audio function circuitry 1209, including a microphone 1211 and microphone amplifier that amplifies the sound signal output from the microphone 1211. The amplified sound signal output from the microphone 1211 is fed to a coder/decoder (CODEC) 1213. In some embodiments, the audio function circuitry 1209 may include a receiver/transmitter unit including a microphone gain control unit and a speaker gain control unit.

The mobile terminal 1201 may also include a radio section 1215, which amplifies power and converts frequency in order to communicate with a base station, which is included in a mobile communication system, via antenna 1217. Generally, a radio receiver is often defined in terms of front-end and back-end characteristics. The front-end of the receiver encompasses all of the Radio Frequency (RF) circuitry whereas the back-end encompasses all of the base-band processing circuitry. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The MCU 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

As shown in FIG. 12, the MCU 1203 is in communication with various input/output components 1207 may be configured to receive various signals therefrom and send signals thereto. The MCU 1203, input/output components 1207, in combination with other user input components (e.g., the microphone 1211), comprise a user interface circuitry for managing user input. The MCU 1203 may run a user interface software to facilitate user control of at least some functions of the mobile terminal 1201. The MCU 1203 may also deliver a display command and a switch command to the input/output components 1207 and to the speech output switching controller, respectively. Further, the MCU 1203 may exchange information with the DSP 1205 and can access an optionally incorporated SIM card 1247 and a memory 1249. In addition, the MCU 1203 may execute various control functions required. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 may include the ADC 1223 and DAC 1243. The memory 1249 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory 1251 may be, but not is limited to, a single memory, CD, DVD, ROM, RAM, EEPROM, optical storage, or any other non-volatile or non-transitory storage medium capable of storing digital data.

An optionally incorporated SIM card 1247 may carry, for instance, important information, such as the cellular phone number, the carrier supplying service, subscription details, and security information. The SIM card 1247 serves primarily to identify the mobile terminal 1201 on a radio network. The SIM card 1247 also contains a memory for storing a personal telephone number registry, text messages, and user specific mobile station settings.

In some embodiments, the mobile terminal 1201 may also include a number of sensors 1251. For instance, the mobile terminal 1201 may include one or more image sensors (e.g., camera(s), position sensors (e.g., GNSS or GPS), proximity sensors, light sensors, fingerprint sensors, accelerometer sensors, Hall effect sensors, a barometer, a compass, and many others. As shown, the MCU 1203 may be in communication with such sensors 1251, for instance, by way of a communication network or bus. In some implementations, the MCU 1203 may be configured to control the operation of the sensors 1251, as well as receive and transmit data and information corresponding with data captured by the sensors 1251.

In some implementations, the MCU 1203 may be configured to process, store, and/or transmit image data provided by an image sensor 1207. For example, the MCU 1203 may direct a camera to acquire a series of image frames while the mobile terminal 1201 is moving along a pathway. The MCU 1203 may tag the image data with a variety of information, including timestamps, positions, orientations, etc. As such, the MCU 1203 may include or have access to a clock, position data, orientation data, and so forth. In some embodiments, the MCU 1203 may be configured to carry out synchronization, in accordance with methods described herein. To this end, the MCU 1203 may access or receive position data, and process the position data, along with the image data, including assembling trajectories, computing spatial transformations, and synchronizing, as described. For instance, a clock responsive to the MCU 1203 and/or the image data may be synchronized in accordance with the processing performed.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order. It should be appreciated that many equivalents, alternatives, variations, and modifications, aside from those expressly stated, are possible and may be considered within the scope of the invention.

We (I) claim:

1. A method of selecting a navigation map for utilization in a region, the method comprising:
determining, for one or more areas, a plurality of scores corresponding respectively to a plurality of digital maps;
selecting a digital map of the plurality of digital maps based on a value of a score of the plurality of scores; and
providing the selected digital map to a device to utilize one or more navigation functions in a location within the one or more areas.

2. The method of claim 1, further comprising:
receiving data captured via one or more sensors of a vehicle, wherein the data captured corresponds to the one or more areas;
determining a second score based on the data captured via the one or more sensors of the vehicle and map data of the selected digital map; and
updating the score of the selected digital map based on the second score.

3. The method of claim 2, further comprising:
comparing the updated score of the selected digital map to a threshold; and
based on satisfying the threshold, selecting a second digital map of the plurality of digital maps and providing the second digital map to the device.

4. The method of claim 1, wherein the plurality of scores corresponding respectively to the plurality of digital maps are based on a plurality of scores of a plurality of layers of the plurality of digital maps.

5. The method of claim 1, further comprising:
receiving a review score via an input of the device, wherein the review score corresponds to the one or more areas;
determining a revised score based on the review score; and
updating the score of the selected digital map based on the revised score.

6. An apparatus comprising:
a processor; and
a memory comprising computer program code for one or more programs, wherein the memory and the computer program code is configured to cause the processor of the apparatus to:
receive a score corresponding to a digital map;
receive data captured via at least one or more sensors of a vehicle, wherein the data captured corresponds to the digital map;
determine a revised score corresponding to the digital map based on the data captured via the at least one or more sensors of the vehicle and map data of the digital map; and
update the score of the digital map based on the revised score.

7. The apparatus of claim 6, wherein the data captured via the at least one or more sensors of the vehicle is image data.

8. The apparatus of claim 7, wherein the memory and the computer program code is further configured to cause the processor of the apparatus to:
decrease the score by a predetermined amount based on one or more determined differences between the image data captured via the at least one or more sensors of the vehicle and the map data of the digital map.

9. The apparatus of claim 6, wherein the memory and the computer program code is further configured to cause the processor of the apparatus to:
determine a difference in one or more speed limits captured via the at least one or more sensors of the vehicle and one or more speed limits based on the map data of the digital map, wherein the one or more speeds limits captured via the at least one or more sensors of the vehicle is captured at one or more locations corresponding to the digital map; and
based on the difference, update the score of the digital map.

10. The apparatus of claim 6, wherein the memory and the computer program code is further configured to cause the processor of the apparatus to:
determine a difference in one or more lane markings captured via the at least one or more sensors of the vehicle and one or more lane markings based on the map data of the digital map, wherein the one or more lane markings captured via the at least one or more sensors of the vehicle is captured at one or more locations corresponding to the digital map; and
based on the difference, update the score of the digital map.

11. The apparatus of claim 6, wherein the memory and the computer program code is further configured to cause the processor of the apparatus to:
determine a difference in one or more road dividers captured via the at least one or more sensors of the vehicle and one or more road dividers based on the map data of the digital map, wherein the one or more road dividers captured via the at least one or more sensors of the vehicle is captured at one or more locations corresponding to the digital map; and
based on the difference, update the score of the digital map.

12. The apparatus of claim 6, wherein the score corresponding to the digital map is based on a plurality of scores of a plurality of layers of the digital map.

13. The apparatus of claim 12, wherein the plurality of layers includes at least a road boundary layer, wherein the memory and the computer program code is configured to further cause the processor of the apparatus to:
determine one or more differences in data captured via the at least one or more sensors of the vehicle and data corresponding to the road boundary layer; and
based on the difference, update the score of the digital map.

14. The apparatus of claim 12, wherein the plurality of layers includes at least a points of interest layer, wherein the memory and the computer program code is configured to further cause the processor of the apparatus to:
determine one or more differences in data captured via the at least one or more sensors of the vehicle and data corresponding to the points of interest layer; and
based on the difference, update the score of the digital map.

15. The apparatus of claim 12, wherein the plurality of layers includes at least a speed limit layer, wherein the memory and the computer program code is configured to further cause the processor of the apparatus to:
determine one or more differences in data captured via the at least one or more sensors of the vehicle and data corresponding to the speed limit layer; and
based on the difference, update the score of the digital map.

16. The apparatus of claim 12, wherein the plurality of layers includes at least a traffic layer, wherein the memory and the computer program code is further configured to cause the processor of the apparatus to:
determine one or more differences in data captured via the at least one or more sensors of the vehicle and data corresponding to the traffic layer; and
based on the difference, update the score of the digital map.

17. A non-transitory computer-readable storage medium comprising one or more sequences of one or more instructions for execution by one or more processors of a device with a display screen and one or more input devices, the one or more instructions which, when executed by the one or more processors, cause the device to:
identify location information associated with a vehicle;
determine scores for different applications based on the location information; and
select an application of the different applications for the vehicle or device thereof based on a score of the determined scores.

18. The non-transitory computer-readable storage medium of claim 17, wherein the one or more instructions which, when executed by the one or more processors, further cause the device to:
receive data captured via at least one or more sensors of at least one other vehicle, wherein the data corresponds to the application;
determine a revised score based on the data captured via the at least one or more sensors of the at least one other vehicle; and
update the score of the application based on the revised score.

19. The non-transitory computer-readable storage medium of claim 18, wherein the one or more instructions which, when executed by the one or more processors, further cause the device to:
compare the score of the application to a threshold; and
based on satisfying the threshold, select another application of the different applications.

20. The non-transitory computer-readable storage medium of claim 17, wherein the one or more instructions which, when executed by the one or more processors, further cause the device to:
receive a review score via an input within the vehicle, wherein the review score corresponds to the application;
determine a revised score based on the review score; and
update the score of the application based on the revised score.
